(19) United States
(12) Patent Application Publication
(10) Pub. No.: US 2008/0216071 A1
(43) Pub. Date: Sep. 4, 2008

(54) Software Protection

(75) Inventor: Nikolco Gidalov, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/910,530

(22) PCT Filed: Apr. 3, 2006
(86) PCT No.: PCT/IB2006/051003

§ 371 Date: Oct. 3, 2007

(30) Foreign Application Priority Data
Apr. 7, 2005 (EP) 05102722.5

(51) Int. Cl. G06F 21/00

(52) U.S. Cl. 718/1

(57) ABSTRACT

The invention relates to software protection. A method is disclosed whereby an original executable, which can be run on a computer device with an execution environment, is wrapped in an alternative execution environment for thereby forming a new executable, and thus calls from the original executable to the operating system of the computer devices can no longer be inspected or manipulated. Hereby, the executable is protected against examination and reverse engineering.

This invention relates to a method for protecting an executable on a computer device against inspection and/or manipulation, said computer device comprising an execution environment for execution of the executable.

It is a well known problem that software on computer devices can be subject to fraudulent examination, tampering, reverse engineering, etc. This problem is becoming more and more severe as more and more of computers are, at least once in a while, connected with other computers via network, such as Extranet, Intranet, Internet, etc.

Shell packager utilities exist, which use a compression algorithm to pack an executable and combine it with a decompression code. The resulting executable has a bootstrap code that first decompresses the compressed executable in memory and calls the entry point of the executable. However, reverse engineering is possible if executables are compressed via current packager utilities, since the executable will be available in a memory medium of a computer. Moreover, spying of calls from the executable to the operating system (OS), registry or memory is possible with the current compressed executables after their decompression.

U.S. Pat. No. 6,006,328 describes protection of software against eavesdropping, tampering, examination, tracing and spoofing. This protection is obtained by means of a combination of encryption, obfuscation, anti-tracing, anti-tamper, self-verification, runtime self-monitoring, and audiovisual authentication techniques. However, this is a complex combination requiring relatively extensive logging of the processes of the techniques.

It is therefore an object of the invention to provide an alternative way of enhancing software protection against inspection and/or manipulation. This object is achieved when the method of the opening paragraph comprises the steps of: generating an alternative execution environment containing realizations of operating system (OS) calls; and combining the original executable and the alternative execution environment to a new executable.

Hereby, the original executable is packed/wrapped into the new executable comprising the alternative execution environment, and thus calls from the original executable to the operating system of the computer devices can no longer be inspected or manipulated. This provides a protection of the executable against any type of inspection and manipulation. As current operating systems and compilers typically use the so-called dynamic linking method for calling the Application Program Interface (API) provided by the operating system, the original executable typically comprise calls to the operating system. Such calls could be calls to libraries and functions that realize the API-services of the Operating System.

Throughout this specification, the term “inspection and/or manipulation” is meant to cover any of the following: eavesdropping, tampering, examination, reverse engineering, API hijacking, API injection and API spying. Moreover, the term “executable” is meant to cover any software or file containing a program, i.e. software or a file capable of being executed or run as a program in a computer device. The term “realization of OS calls” is meant to cover any way to perform calls corresponding to the OS calls in the original executable. Finally, the term “call” is meant to be synonymous with “command” or “request”.

Preferably, the method comprises the step of translating any calls in the original executable to corresponding calls realized in the alternative execution environment. In this translating step of the method, references or calls in the original executable to e.g. dynamically linked libraries are replaced by or translated to calls realized in the alternative execution environment. Hereby, it is ensured that the functioning of the new executable corresponds to the functioning of the original executable. The step of translating the calls in the original executable can be performed by working through a table in the original executable containing references to dynamically linked libraries and replacing these references to calls that are realized in the alternative execution environment.

In a preferred embodiment, the alternative execution environment comprises a virtual operating system. This virtual operating system is arranged to perform the task of the operating system in relation to the original executable, when any calls in the original executable has been translated to corresponding calls in the virtual operating system. However, such calls in the virtual operating system will not be detectable outside the virtual operating system.

In yet a preferred embodiment of the method according to the invention, the alternative execution environment moreover comprises one or more of the following components: virtual file system, virtual registry, virtual process manager, virtual resource manager. Whether each of these components should be included in the alternative execution environment, will depend upon which components are called in the original executable, so that components not called in the original executable need not be included in the alternative execution environment and vice versa.

Preferably, the step of combining in the method according to the invention further comprises combining the new executable with a bootstrap code. Hereby, the new executable can be loaded into a computer device and executed thereon by use of the bootstrap code.

In a preferred embodiment of the method, it further comprises a previous step of identifying any call(s) in the original executable; whereby the step of generating the alternative execution environment comprises generating realizations only of the any call(s) identified in the original executable. Hereby, it is prevented to generate alternative execution environments being excessively complex or large.

In yet a preferred embodiment of the method, said alternative execution environment is generated to comprise realizations of the most common operating system (OS) calls. These most common operating system (OS) calls e.g. include file system calls, registry calls, process management calls and resource management calls). Hereby, any identification of the calls in the original executable is prevented.

The invention will be explained more fully below in connection with a preferred embodiment and with reference to the drawing, in which:

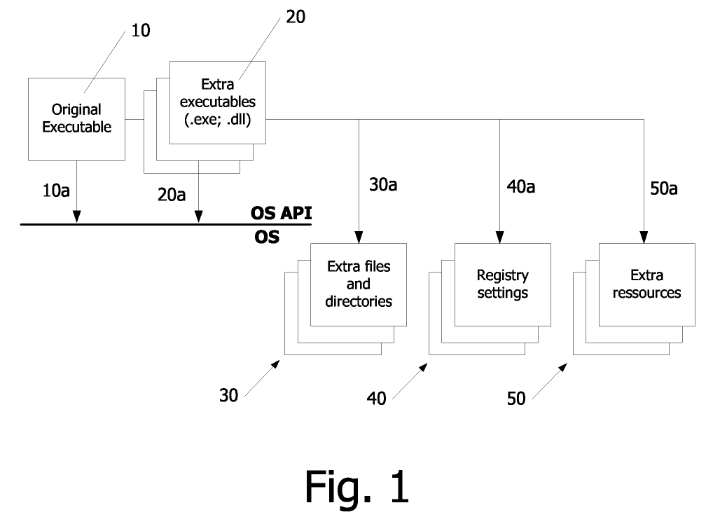

FIG. 1 is a schematic diagram of the components of a prior art execution environment;

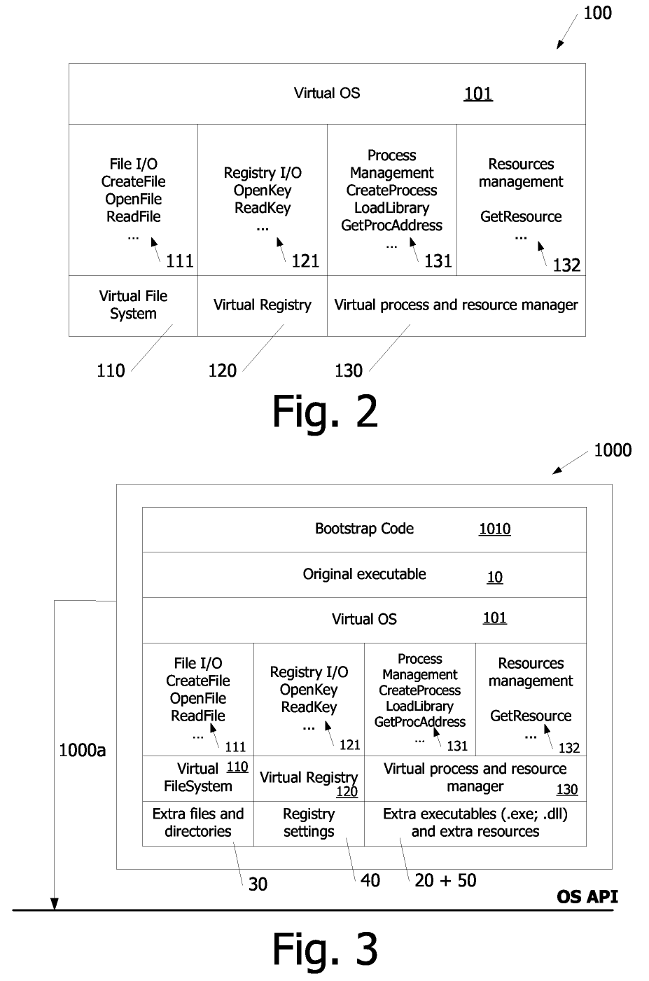

FIG. 2 is a schematic diagram of the components of an alternative execution environment according to the invention;

FIG. 3 is a schematic diagram of a new executable according to the invention; and

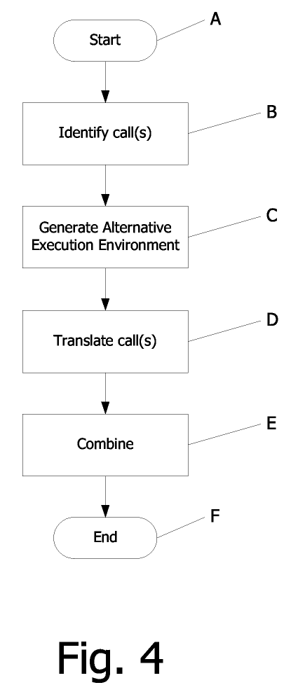

FIG. 4 is a flow chart of an exemplary method of the invention.

Throughout the description of the figures, it is to be understood that the components therein are part of hardware, software or middleware, which can be realized in a computer device. It is moreover understood that the computer device comprises an Operating System (OS), e.g. a program that, after being initially loaded into the computer device, manages all the other programs in the computer device. The other programs are called executables or application programs. The executables or application programs make use of the operating system by making calls or requests for services through a defined application program interface (OS API). This OS API is indicated in the figures as a horizontal line and calls to the OS API are indicated by arrows pointing to this. Calls directly to the operating system (OS) are indicated as arrows pointing to elements situated below this horizontal line.

It is also understood that the computer device typically comprise appropriate components, such as registries, storage means, processor unit(s), input/output means, display means, etc. However, these are not shown in the Figures.

FIG. 1 is a schematic diagram of the components of a prior art execution environment. Shown are an original executable 10. This executable can make calls to the OS API, indicated by the arrow 10a. Extra executables 20 can be involved in the execution of the executable 10; these extra executables 20 might themselves make calls to the OS API, indicated by the arrow 20a. The arrow 30a indicates a call from the original executable 10 or the extra executables 20 to extra files and/or directories 30 in a file system. The arrow 40a indicates a call from the original executable 10 or the extra executables 20 to a registry, e.g. for reading registry settings 40. Finally, the arrow 50a indicates a call from the original executable 10 or the extra executables 20 to extra resources 50. Such calls 30a, 40a, 50a are handled by the operating system OS, e.g. sent to the OS which manages access to the files, directories, resources, etc.

It is clear from the above description of FIG. 1, that the original executable can be reverse engineered to reveal the calls 10a-50a to the OS API and the OS, e.g. by API-hijack or API injection methods. When the original executable 10 tries to access a file on a memory device in the computer device or to access a key in a registry in the computer device, API spy tools can be used to monitor and spy the calls.

FIG. 2 is a schematic diagram of the components of an alternative execution environment 100 according to the invention. The alternative execution environment 100 comprises a virtual operating system 101, a virtual file system 110, a virtual registry 120 and a virtual process and resource manager 130. The virtual OS 101 can make calls 111 to the virtual file system 110 regarding File I/O, such as “Create File”, “Open File”, “Read File”, etc. Moreover, the virtual OS 101 can make calls 121 to the virtual registry 120 regarding as Registry I/O, such as “Open Key”, “Read Key”, etc. Finally, the virtual OS can make calls 131 regarding process management and/or calls regarding resource management 132 to the virtual process and resource manager 130, such as “Create process”, “Load Library”, “Get Resource”, etc.

The components of the alternative execution environment shown in FIG. 2 are only exemplary and other or alternative components could be part of the alternative execution environment depending on the calls in the original executable.

FIG. 3 is a schematic diagram of a new executable 1000 according to the invention. The new executable 1000 is the result of processing and wrapping the original executable 10 in the alternative execution environment 100. Thus, the new executable 1000 contains the original executable 10, extra executables 20, extra files and directories 30, the registry settings 40 and the extra resources 50 shown in FIG. 1. Moreover, the new executable 1000 contains the virtual OS 100, the virtual file system 110, the virtual registry 120 and the virtual process and resource manager 130, shown in FIG. 2, as well as the calls 111, 121, 131 and 132. Moreover, as shown in FIG. 3 the new executable 1000 comprises a bootstrap code 1010 for loading the new executable 1000 into memory and allowing it to begin execution.

It should be noted, that the original executable 10 in FIGS. 1 and 3 could be compressed.

FIG. 4 is a flow chart of an exemplary method of the invention. The shown method starts in step A. In a subsequent step, step B, any calls in an original executable are identified. These calls typically are calls to the operating system. Subsequently, in step C, an alternative execution environment is generated. This alternative execution environment should comprise realizations of operating system calls. The alternative execution environment can comprise a virtual operating system and possibly one or more of the following: a virtual file system, a virtual registry, a virtual process manager, a virtual resource manager. Thereafter, in step D, the calls in the original executable, which were identified in step B, are translated to corresponding calls realized in the alternative execution environment. The method continues to step E, wherein the original executable and the alternative execution environment are combined to a new executable. Preferably, the new executable is also combined with a bootstrap code. The flow ends in step F.

It should be emphasized that the term “comprises/comprising” when used in this specification is taken to specify the presence of stated features, integers, steps or components but does not preclude the presence or addition of one or more other features, integers, steps, components or groups thereof. The mere fact that certain measures are recited in mutually different dependent claims or described in different embodiments does not indicate that a combination of these measures cannot be used to advantage.

1. A method for protecting an executable on a computer device against inspection and/or manipulation, said computer device comprising an execution environment for execution of the executable, characterized in that said method comprising the steps of:
generating (C) an alternative execution environment (100) comprising realizations of operating system (OS) calls; and
combining (E) the original executable (10) and the alternative execution environment (100) to a new executable (1000).

2. A method according to claim 1, characterized in further comprising the step of:
translating any calls (D) in the original executable (10) to corresponding calls realized in the alternative execution environment (100).

3. A method according to claim 1, characterized in that the alternative execution environment (100) comprises a virtual operating system (101).

4. A method according to claim 3, characterized in that the alternative execution environment (100) moreover comprises one or more of the following components: virtual file system (110), virtual registry (120), virtual process manager (130), virtual resource manager (130).

5. A method according to claim 1, characterized in that the step of combining further comprises combining the new executable (1000) with a bootstrap code (1010).

6. A method according to claim 1, characterized in further comprising a previous step of:
identifying any call(s) (B) in the original executable (10);
whereby the step of generating the alternative execution environment (100) comprises generating realizations only of the any call(s) identified in the original executable (10).

7. A method according to claim 1, characterized in that said alternative execution environment (100) is generated to comprise realizations of the most common operating system (OS) calls.

8. A computer program comprising program code means adapted to cause a data processing device to perform the steps of the method according to claim 1, when said computer program is run on the data processing device.

9. A data processing device comprising a first processing circuit adapted to perform the method according to claim 1.
